(19) United States
(12) Patent Application Publication
(10) Pub. No.: US 2009/0253064 A1
(43) Pub. Date: Oct. 8, 2009

(54) PROCESS AND COMPOSITION FOR CREATING CUSTOMIZED COLORS BY USING A SERIES OF NEUTRAL GRAY PRIMARIES

(75) Inventors: Kip L. Jugle, Bloomfield, NY (US); James A. Winters, Alfred Station, NY (US); Mark Alan Scheuer, Williamson, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/098,745

(22) Filed: Apr. 7, 2008

(51) Int. Cl. G03G 9/09

(52) U.S. Cl. 430/107.1; 430/137.21

(57) ABSTRACT

A process for creating custom colors including: creating a plurality of neutral gray scale primary components of varying darkness levels; selecting one or more non-gray scale primary components; and combining one or more of the plurality of neutral gray scale primary components with the one or more non-gray scale primary components; the plurality of neutral gray scale primary components are compatible with dry blending techniques of the one or more non-gray scale primary components in order to shift a hue of a designated target primary.

### TECHNICAL FIELD

The present disclosure relates to toners, and, more specifically, to a process and composition for creating customized colors by using a series of neutral gray primaries.

### BACKGROUND

In the process of electro-photographic printing, a photoreceptor containing a photoconductive insulating layer on a conductive layer is imaged by uniformly electrostatically charging the surface. The photoreceptor is then exposed to a pattern of activating electromagnetic radiation, such as light. The radiation selectively dissipates the charge in the illuminated areas of the photoconductive insulating layer, while an electrostatic latent image is formed on the non-illuminated areas. Toner particles are attracted from carrier granules to the latent image to develop the latent image. The toner image is then transferred from the photoconductive surface to a sheet and fused onto the sheet.

Various toner compositions for such a printing system are well known in the art and have been produced having a wide array of additives and constituent materials. Generally, toner particles include a binding material, such as a resin, and any of various additives to provide particular properties to the toner particles. Numerous devices and processes are known for preparing toner particles. Numerous different types of xerographic imaging processes are known wherein, for example, insulative developer particles or conductive developer particles are selected depending on the development systems used. Moreover, of interest with respect to the aforementioned developer compositions is the appropriate triboelectric charging values associated therewith, as it is these values that may enable continued formation of developed images of high quality and excellent resolution.

Triboelectric charging is widely used in the electro-photographic industry to charge toner particles. Triboelectric charging is performed by rubbing two dissimilar materials together, and in the course of such rubbing, a charge is transferred from one body to the other. A disadvantage is that the triboelectric charging phenomenon is very sensitive to surface conditions of the particle as well as temperature and humidity. Charge deposited on particles, particularly irregularly surfaced particles, can easily become non-uniform, resulting in localized areas of higher charge concentration on the particles. This increases the localized adhesion state of such particles to any surface, including the internal structural surfaces of the devices within which the electrostatically charged particles are manipulated.

In two component developer compositions, carrier particles are used in charging the toner particles. Toner particles are mixed with larger, magnetic particles called carrier particles. The toner and carrier particles often contain charge agents that enable the toner particles to become triboelectrically charged by contact with the carrier particles. The developer is contained in a development station that typically includes a roller with a magnetic core, a sump that contains a quantity of developer, a device for determining the concentration of toner in the developer, and a mechanism for replenishing the toner when the toner concentration drops below a certain level. The carrier particles transport the toner into contact with the imaging member bearing the electrostatic latent image. The development station is suitably biased and the toner particles suitably charged so that the proper amount of toner particles is deposited in either the charged or discharged regions of the imaging member.

After the electrostatic latent image on the imaging member has been developed, the toned image is generally transferred to a receiver such as paper or transparency stock. This is generally accomplished by applying an electric field in such a manner to urge the toner from the imaging member to the receiver. In some instances, it is preferable to first transfer the toned image from the imaging member to an intermediate member and then from the intermediate member to the receiver.

Dry blending processes and other mixing to incorporate a carbon black or other conductive material into the polymer coating can be selected, however, to avoid, or minimize transfer of the carbon black from the polymer coating the amount of carbon black that may be blended may be limited, for example, to 20 percent by weight or less, which limits the conductivity achievable by the resultant conductive polymer. In addition, dry blending is the process for powder coatings manufacture where materials are blended in dry form without melting.

A color can be uniquely described by three main perceptual attributes: hue, denoting whether the color appears to have an attribute according to one of the common color names, such as red, orange, yellow, green, blue, or purple (or some point on a continuum); colorfulness, which denotes the extent to which hue is apparent; and brightness, which denotes the extent to which an area appears to exhibit light. Light sources used to illuminate objects for viewing are typically characterized by their emission spectrum and to a reduced degree by their color temperature, which is primarily relevant for characterization of sources with a spectrum similar to a black body radiator. Lightness is the perceptual response to luminance; denoted L* and is defined by the CIE as a modified cube root of luminance. Common notation indicates the lightness or darkness of a color in relation to a neutral grey scale, which extends from absolute black to absolute white.

Gray scale is a strip of standard gray tones, ranging from white to black, placed at the side of original copy during photography to measure tonal range and contrast obtained. A gray scale digital image is an image in which the value of each pixel is a single sample. Displayed images of this sort are typically composed of shades of gray, varying from black at the weakest intensity to white at the strongest, though in principle the samples could be displayed as shades of any color, or even coded with various colors for different intensities. Gray scale images are distinct from black-and-white images, which in the context of computer imaging are images with only two colors, black and white, whereas gray scale images have many shades of gray in between.

Primary Colors are usually three colors, which are combinable to produce a range of other colors within a color mixing model. All non-primary colors are mixtures of two or more primary colors. Red, green, and blue (R, G, B) are the standard additive primary colors. Cyan, magenta, and yellow (C, M, Y) are the standard subtractive primary colors. Black (K) colorant absorbs light energy substantially uniformly over the full extent of the visible spectrum and may be added to enhance color and contrast and to improve certain printing characteristics. Cyan, magenta, and yellow (CMY) are the subtractive complements of red, green, and blue, (RGB) respectively, and they absorb the light energy in the long, middle, and short wavelength regions, respectively, of the visible spectrum, leaving other regions of the visible spectrum unchanged. Ideally, the absorption bands of individual CMY colorants are non-overlapping and completely cover the visible region of the spectrum.

Two predominant modes for producing color are: additive color, whereby color is produced by the addition of spectrally selective lights to a dark background that is otherwise substantially devoid of light; and subtractive color, whereby color is produced by spectrally selective subtraction of light energy from the light emitted by a source. Red, green and blue lights are typically used as the primaries that are mixed together in an additive system. In a subtractive system, colorants are typically used as the subtractive primaries. These colorants selectively absorb, or subtract, a portion of the visible spectrum of incident light while transmitting the remainder. Cyan, Magenta, and Yellow colorants are typically used.

Color in printed images results from the combination of a limited set of colorants deposited on a substrate over a small area in densities selected to integrate the desired color response. This is accomplished in many printing devices by reproducing so called “separations” of the image, where each separation provides varying gray values of a single primary color. When the separations are combined together, the result is a full color image.

Colorants that are deposited on a reflective substrate, such as a paper sheet, selectively transmit incident light in a first pass to the surface of the substrate whereupon the transmitted light is then reflected by the substrate and is again filtered by the colorants in a second pass, thus encountering additional selective absorption before being perceptible as a particular color by an observer. It is also common for colorants to possess a degree of scattering, and the color appearance of a colorant on a printed substrate is determined by the amount and types of the colorants present, and the combination of their absorption and scattering properties.

Thus, cyan, magenta, and yellow colorants absorb red, green and blue light, respectively. The idealized absorption bands for the cyan, magenta, and yellow colorants are referred to as the block-dye assumption. In reality, colorants exhibit significant deviations from this idealized behavior, including scattering in the colorants. Thus, dry blended custom colors that lie in the neutral region have the potential for greater visual color variation due to their proximity to the neutral axis. In other words, small variations in dE caused by errors in primary constituents and/or instabilities caused by the printing process, i.e., xerography can lead to large shifts in the hue angle. These hue angle shifts often are very perceptible to the eye because they can be very different shades of colors, i.e., brown or green vs. gray. Without a neutral gray primary, these colors can currently be made using black and white to tune to a gray color, which leads to higher graininess appearance in the blend due to the combination of particles which have a large contrast, i.e., black compared to white.

None of these methods has presented a desirable solution for minimizing the graininess appearance in the blend to acceptable levels. Therefore, it would be highly desirable to provide a process and composition that provides for and enables an efficient and reliable method of customizing colors by successfully shifting the hue of a desired target primary color in order to minimize the graininess appearance of color primaries.

### SUMMARY

A process for creating custom colors, the process comprising: creating a plurality of neutral gray scale primary components of varying darkness levels; selecting one or more non-gray scale primary components; and combining one or more of the plurality of neutral gray scale primary components with the one or more non-gray scale primary components; the plurality of neutral gray scale primary components are compatible with dry blending techniques of the one or more non-gray scale primary components in order to shift a hue of a designated target primary.

A composition for creating custom colors, the composition comprising: a first toner device for creating a plurality of neutral gray scale primary components of varying darkness levels; and a second toner device for creating one or more non-gray scale primary components; wherein the one or more of the plurality of neutral gray scale primary components are combined with the one or more non-gray scale primary components; and the plurality of neutral gray scale primary components are compatible with dry blending techniques of the one or more non-gray scale primary components in order to shift a hue of a designated target primary.

A computer program product for creating custom colors, the computer program product comprising: a storage medium readable by a processing circuit and storing instructions for execution by the processing circuit for facilitating a method comprising: creating a plurality of neutral gray scale primary components of varying darkness levels; selecting one or more non-gray scale primary components; and combining one or more of the plurality of neutral gray scale primary components with the one or more non-gray scale primary components; the plurality of neutral gray scale primary components are compatible with dry blending techniques of the one or more non-gray scale primary components in order to shift a hue of a designated target primary.

### BRIEF DESCRIPTION OF THE DRAWINGS

FIG. 1 illustrates a CIELAB plot including a plurality of primary colors as well as a plurality of neutral grey primaries in accordance with the exemplary embodiments of the present disclosure;

FIG. 2 illustrates combining one or more of the plurality of primary colors with one or more of the plurality of neutral grey primaries to create a desired target primary in accordance with the exemplary embodiments of the present disclosure;

FIG. 3 illustrates a two-dimensional CIELAB plot where a plurality of color primaries are combined with one or more neutral grey primaries that result in a desired target primary in an extensive color gamut (Pantone) in accordance with the exemplary embodiments of the present disclosure; and

FIG. 4 illustrates a two-dimensional CIELAB plot where an undesirable grainy image is produced due to the proximity of the desired target primary color to an originally selected proximate primary color.

### DETAILED DESCRIPTION

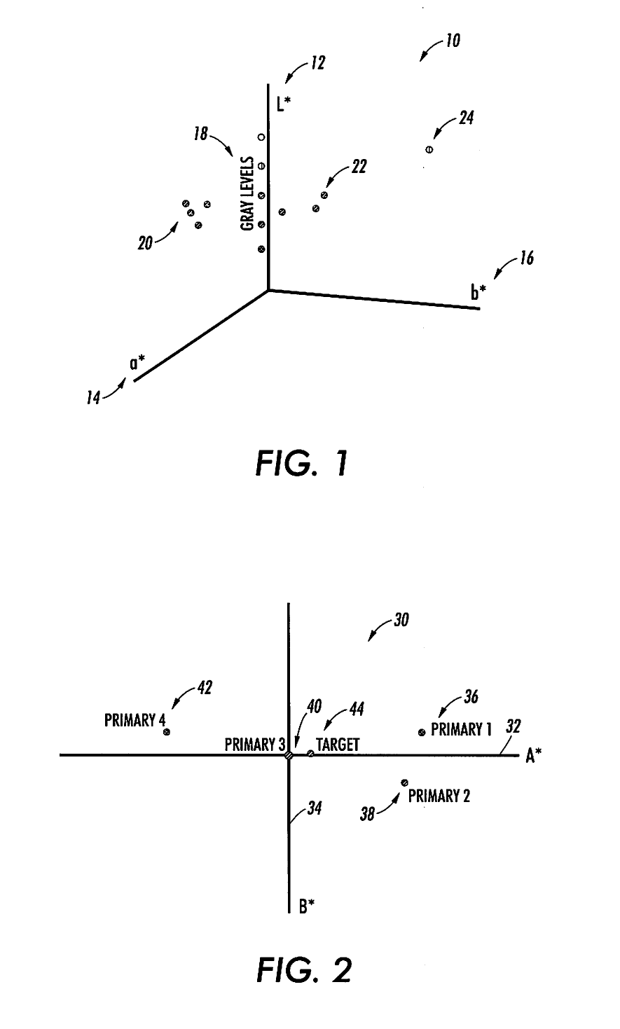

The exemplary embodiments of the present disclosure pertain to creating a series of neutral gray primaries of varying darkness (L*) in combination with the other primary colors to create dry blended custom colors. This new series of neutral gray primaries falls along the neutral axis, thus splitting up the color space stretching from white to black. The series can consist of one or more neutral gray primaries. The creation of the additional neutral gray primaries along the L* axis can be used to formulate the desired neutral colors mentioned above which can be difficult. The neutral gray primaries may also be used in blend formulations instead of white and black to modify the L* of a color which can in many cases lead to lower color graininess. These features and aspects will become better understood with regard to the following description of the exemplary embodiments. However, before describing FIGS. 1 and 2, it is appropriate to provide a brief description of the CIE color space.

CIE L*a*b* (CIELAB) is a color model used conventionally to describe all the colors visible to the human eye. It was developed for this specific purpose by the International Commission on Illumination. The asterisk (*) after L, a, and b is part of the full name, since they represent L*, a* and b*, to distinguish them from L, a, and b.

The three basic coordinates represent the lightness of the color (L*, L*=0 yields black and L*=100 indicates white), its position between red/magenta and green (a*, negative values indicate green while positive values indicate magenta) and its position between yellow and blue (b*, negative values indicate blue and positive values indicate yellow).

The L*a*b* color model has been created to serve as a device independent model to be used as a reference. Therefore, the visual representations of the full gamut of colors in this model are not always accurate. They are there just to help in understanding the concept, but they are inherently inaccurate. Since the L*a*b* model is a three-dimensional model, it can only be represented properly in a three-dimensional space. However, in some of the exemplary embodiments of the present disclosure the L*a*b* model is presented as a two-dimensional model for convenience. FIGS. 1 and 2 can now be better understood in regards to this explanation.

FIG. 1 illustrates a CIELAB plot including a plurality of primary colors as well as a plurality of neutral grey primaries, in accordance with the exemplary embodiments of the present disclosure. The plot 10 includes an L* axis 12, a* axis 14, b* axis 16, a series of neutral gray primaries 18, a plurality of blue primaries 20, a plurality of red primaries 22, and a yellow primary 24.

The series of neutral gray primaries 18 can be produced by using conventional toner manufacturing, as well as chemical toner manufacturing. The pigment levels (e.g., carbon black and/or pigments) are selected to produce varying levels of gray along the neutral axis, L* axis 12 of the L*, a*, b* plot 10. The series of neutral gray primaries 18 can be produced in a manner that is compatible with dry blending with toners of a same product line.

By using the series of neutral gray primaries 18 shown in FIG. 1, any neutral gray primary may be produced by dry blending combinations of the gray primaries, white primaries and black primaries. These combinations of colors when introduced to the stresses of xerography, as well as formulation error from manufacturing cannot shift in hue angle because all of the primaries in the formulation are of the same hue. For gray colors which are slightly off the neutral axis, any combination of the other primaries (e.g., blue primaries 20, red primaries 22 or yellow primary 24) may be used to slightly shift the hue to the desired target (shown in FIG. 2). These formulations are also much more stable in hue because all these hues can be produced with combinations of the grays, black, white, and a combination of no more than two of the other primaries which are adjacent to each other (e.g., blue primaries 20, red primaries 22 or yellow primary 24).

In addition, within the color space of the plot 10, any hue angle can be achieved by combining two of the 3 primaries (e.g., blue primaries 20, red primaries 22 and/or yellow primary 24). The intention of combining these colors is to move the target primary hue towards grey (decrease saturation), which is known as the graying agent. However, as that graying agent has an inherent hue of its own, it also shifts its hue as it changes the saturation of the resulting color. The most efficient way to change the saturation of a given color while maintaining the same hue angle is to combine one or more color primaries (e.g., blue primaries 20, red primaries 22 or yellow primary 24) with one or more of the series of gray neutral primaries 18.

FIG. 2 illustrates combining one or more of the plurality of primary colors with one or more of the plurality of neutral grey primaries to create a desired target primary, in accordance with the exemplary embodiments of the present disclosure. The plot 30 includes a* axis 32, b* axis 34, a first primary 36, a second primary 38, a third primary 40, a fourth primary 42, and a target primary 44. For illustrative purposes, the first primary 36 is red, the second primary 38 is magenta, the third primary 40 is gray, the fourth primary 42 is green, and the target primary 44 is pink.

FIG. 2 illustrates how a gray primary 40 (primary 3) can be combined with a red primary 36 (primary 1) and magenta primary 38 (primary 2) to build a target primary 44 with a slight pinkish tint. The target primary 44 is very stable in hue angle due to manufacturing errors as well as printing stresses because the possible hue shifts are bracketed between the red primary 36 and the magenta primary 38. This scenario may also be accomplished by combining the gray primary 40 and the green primary 42. In other words, several combinations of primaries with gray primaries may be selected in order to obtain the target primary 44. In addition, the possible hue shifts during printing can be the full range 0 to 360 degrees.

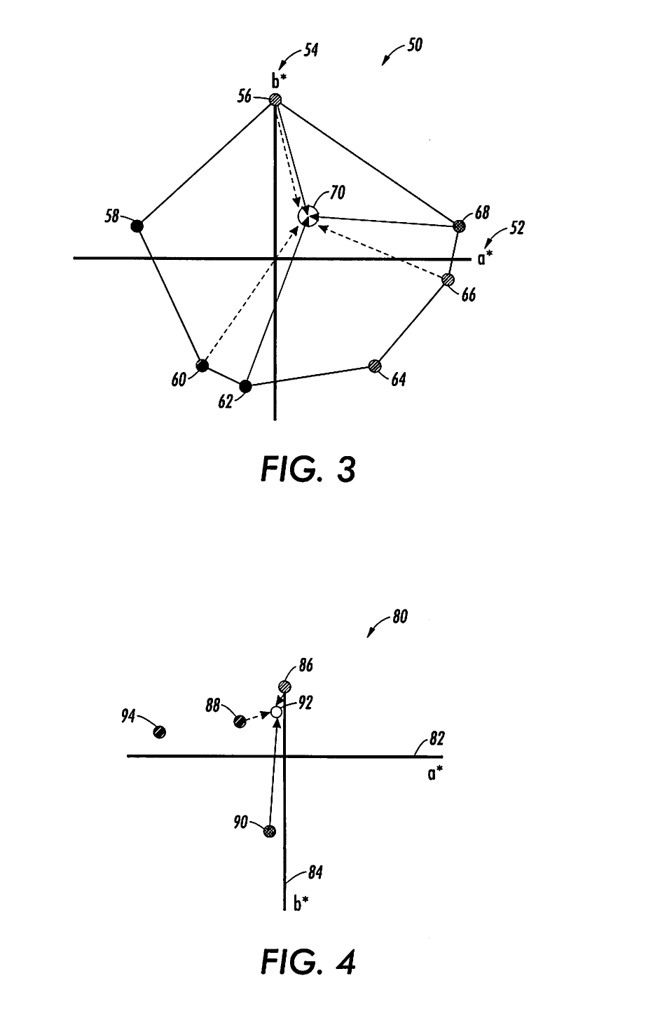

Before describing FIG. 3, it is important to note what is meant by an extensive color gamut. The extensive color gamut of the exemplary embodiments illustrated in FIGS. 3 and 4 refers to a Pantone color space. Pantone Inc. is a corporation that is best known for its Pantone Matching System (PMS), a proprietary color space used in a variety of industries, primarily printing, though sometimes in the manufacture of colored paint, fabric, and plastics. The company's primary products include the Pantone Guides, which consist of a large number of small thin cardboard sheets, printed on one side with a series of related color swatches and then bound into a small flipbook. The idea behind the PMS is to allow designers to “color match” specific colors when a design enters production stage, regardless of the equipment used to produce the color.

The PMS expands upon existing color reproduction systems such as the CMYK process. The CMYK process is a standardized method of printing color by using four inks, which is, cyan, magenta, yellow, and black. The majority of the world's printed material is produced using the CMYK process. The Pantone system is based on a specific mix of pigments to create new colors also referred to as spot colors. The Pantone system also allows for many “special” colors to be produced such as metallics and fluorescents. While most of the Pantone system colors are beyond the printed CMYK gamut, those that it is possible to simulate through the CMYK process are labeled as such within the company's guides. FIGS. 3 and 4 can now be better understood in regards to this explanation.

FIG. 3 illustrates a two-dimensional CIELAB plot where a plurality of color primaries are combined with one or more neutral grey primaries that result in a desired target primary in an extensive color gamut, in accordance with the exemplary embodiments of the present disclosure. The plot 50 includes a* axis 52, b* axis 54, a yellow primary 56, a green primary 58, a cyan primary 60, a blue primary 62, a magenta primary 64, a pink primary 66, a red primary 68, and a target primary 70.

FIG. 3 is basically a recommendation for reproducing the base 14 colors that define the Pantone space so that the entire Pantone color gamut can be recreated using Pantone's mixing formulas. The formulation of color toners has shown to be acceptable to create custom colors by dry blending base toners. Laboratory measurements of 2 and 3 component blends of the above primaries (e.g., yellow primary 56, green primary 58, cyan primary 60, blue primary 62, magenta primary 64, pink primary 66, and/or red primary 68) have shown that the toners do not separate over time and the print color is maintained during the use of the supply of blended toners. In addition, dry blending has economic advantages over fixed color (pigment blended) toners in that a small number of inventoried colors can be manufactured in greater amounts in order to reduce the overall supply costs.

In a similar fashion, dry toners that work in a Docutech 180 HLC print engine can also be formulated into 14 base toners that can be dry blended using Pantone's formulas and some minor fine tuning to provided Xerox Docutech 180 HLC customers with identical custom colors.

To create arbitrary highlight colors within a three-dimensional color gamut, blends of 4 components are needed. In addition to blending red, yellow, and green to get a particular shade of orange, both black and white or black and clear toners are needed to fine tune the darkness of the mixture. In FIG. 3, the base toners are shown by large dots (yellow primary 56, green primary 58, cyan primary 60, blue primary 62, magenta primary 64, pink primary 66, and/or red primary 68). Two-component mixtures can provide colors on the lines connecting the dots. Points within the enclosed surface usually require blending of 3 toners. Points falling inside the color space but off the surface usually require a 4^{th} toner (black, white or clear) to provide the correct L* value.

FIG. 4 illustrates a two-dimensional CIELAB plot where an undesirable grainy image is produced due to the proximity of the desired target primary color to an originally selected proximate primary color. The plot 80 includes a* axis 82, b* axis 84, a yellow primary 86, a green primary 88, a blue primary 90, a target primary 92, and a magenta primary 94.

When the desired color is relatively close to a parent toner (e.g., yellow primary 86), as shown in FIG. 4, the small amount of the darker color (e.g., blue primary 90) creates objectionable, grainy images. To decrease the grainy appearance of the color, it is proposed that additional primary toners are created within the color space (e.g., green primary 88 and magenta primary 94) in order to offset the grainy image. These toners (e.g., green primary 88 and magenta primary 94) can have the pigments dispersed more uniformly within each particle. As a result of adding more toners, the target primary 92 shown in FIG. 4 can be created with new base toners (e.g., green primary 88 and magenta primary 94), thus requiring more particles of this toner (green or magenta) and less particles of yellow primary 86 in order to successfully create the color of the target primary 92. The reduced contrast of the new base toner (e.g., green primary 88 and magenta primary 94), added to the old toner (e.g., yellow primary 86) provides for higher quality images.

The increased number of base toners needed can be determined experimentally based on acceptable limits of image graininess. While fixed color toners (e.g., blended pigments) may always be less grainy than dry blended toners, adding additional base toners to the set of available components for dry blending extends the use of dry blended toners by creating more acceptable custom colors. As a result, combining one or more primary colors with a series of neutral gray primaries can result in less hue shift of the target primary and thus create less grainy images.

It will be appreciated that variations of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims. The claims can encompass embodiments in hardware, software, or combinations thereof.

1. A process for creating custom colors, the process comprising:
creating a plurality of neutral gray scale primary components of varying darkness levels;
selecting one or more non-gray scale primary components; and
combining one or more of the plurality of neutral gray scale primary components with the one or more non-gray scale primary components;
the plurality of neutral gray scale primary components are compatible with dry blending techniques of the one or more non-gray scale primary components in order to shift a hue of a designated target primary.

2. The process according to claim 1, wherein the varying levels of darkness are produced along a neutral axis (L* axis) of an L*a*b* plot.

3. The process according to claim 1, wherein the non-gray scale primary components are additive colors and subtractive colors.

4. The process according to claim 3, wherein the additive colors are red, green, and blue, and the subtractive colors are cyan, magenta, and yellow.

5. The process according to claim 1, wherein the neutral gray scale primary components are produced by using toner manufacturing techniques.

6. The process according to claim 1, wherein the hue shift is in a range of 0° to 360°.

7. The process according to claim 1, wherein the combination of the plurality of neutral gray scale primary components and the one or more non-gray scale primary components creates a Pantone Matching System color space.

8. A composition for creating custom colors, the composition comprising:
a first toner device for creating a plurality of neutral gray scale primary components of varying darkness levels; and
a second toner device for creating one or more non-gray scale primary components;
the one or more of the plurality of neutral gray scale primary components are combined with the one or more non-gray scale primary components; and
wherein the plurality of neutral gray scale primary components are compatible with dry blending techniques of the one or more non-gray scale primary components in order to shift a hue of a designated target primary.

9. The composition according to claim 8, wherein the varying levels of darkness are produced along a neutral axis (L* axis) of an L*a*b* plot.

10. The composition according to claim 8, wherein the non-gray scale primary components are additive colors and subtractive colors.

11. The composition according to claim 10, wherein the additive colors are red, green, and blue, and the subtractive colors are cyan, magenta, and yellow.

12. The composition according to claim 8, wherein the neutral gray scale primary components are produced by using toner manufacturing techniques.

13. The composition according to claim 8, wherein the hue shift is in a range of 0° to 360°.

14. The composition according to claim 8, wherein the combination of the plurality of neutral gray scale primary components and the one or more non-gray scale primary components creates a Pantone Matching System color space.

15. A computer program product for creating custom colors, the computer program product comprising:
a storage medium readable by a processing circuit and storing instructions for execution by the processing circuit for facilitating a method comprising:
creating a plurality of neutral gray scale primary components of varying darkness levels;
selecting one or more non-gray scale primary components; and
combining one or more of the plurality of neutral gray scale primary components with the one or more non-gray scale primary components;
the plurality of neutral gray scale primary components are compatible with dry blending techniques of the one or more non-gray scale primary components in order to shift a hue of a designated target primary.
